(19) United States
(12) Patent Application Publication
(10) Pub. No.: US 2004/0085922 A1
(43) Pub. Date: May 6, 2004

(54) Apparatus and method for automatic QoS management in a wireless mobile station

(75) Inventor: Sudhindra P. Herle, Plano, TX (US)

Correspondence Address: Docket Clerk, P.O. Drawer 800889, Dallas, TX, 75380, US

(73) Assignee: SAMSUNG ELECTRONICS CO., LTD., Suwon-city (KR)

(21) Appl. No.: 10/284,578

(22) Filed: Oct. 31, 2002

(51) Int. Cl. H04Q 7/00

(52) U.S. Cl. 370/328; 370/338; 370/412; 370/395.2; 370/230.1

(57) ABSTRACT

An apparatus and method is disclosed for providing automatic quality of service (QoS) management in a wireless mobile station. The apparatus comprises a quality of service (QoS) controller that is capable of providing a radio link to a wireless network. The radio link has a set of quality of service (QoS) parameters that support transmission and reception of data packets in a protocol that requires the set of quality of service (QoS) parameters. The quality of service (QoS) controller comprises a processor and a memory that contains quality of service (QoS) management application program, a quality of service (QoS) database, and a radio link database. For data packets that have a quality of service (QoS) requirement, the processor (1) accesses a suitable radio link from the radio link database, or (2) creates a new radio link and adds the new radio link to the radio link database.

### TECHNICAL FIELD OF THE INVENTION

The present invention is directed, in general, to wireless networks and, more specifically, to an apparatus and method for providing quality of service (QoS) management in a wireless mobile station, such as a cellular telephone handset.

### BACKGROUND OF THE INVENTION

The radio frequency (RF) spectrum is a limited commodity. Only a small portion of the spectrum can be assigned to each communications industry. The assigned spectrum, therefore, must be used efficiently in order to allow as many users as possible to have access to the spectrum. Multiple access modulation techniques are some of the most efficient techniques for utilizing the RF spectrum. Examples of such modulation techniques include time division multiple access (TDMA), frequency division multiple access (FDMA), and code division multiple access (CDMA).

In order to attract and retain subscribers, wireless service providers frequently introduce end-user services that are desirable to consumers. One important way to accomplish this is to improve the performance of existing network equipment while making the equipment cheaper and more reliable. Doing this allows the service providers to reduce infrastructure and operating costs while maintaining or even increasing the capacity of their wireless networks. At the same time, the service providers are attempting to improve the quality of telecommunication services and increase the quantity of services available to the end-user.

It is desirable to provide a mobile wireless station (such as a cellular telephone) with systems that optimize bandwidth usage. The amount of bandwidth that is available to a mobile wireless station must be allocated among the radio links that are currently active in the mobile wireless station. Each radio link between a mobile wireless station and the wireless network will consume resources in both the wireless station and the wireless network.

Third generation (3 G) wireless network standards provide methods and techniques for the wireless network to create and delete multiple, simultaneous radio links on demand. The central controller of a 3 G wireless network plays a significant role in determining when radio links are created and deleted. Third generation (3 G) wireless network standards presently do not provide any methods or techniques to enable the wireless stations to automatically determine the optimal time to create new radio links.

There is therefore a need in the art for an improved apparatus and method to enable wireless stations in a wireless network to automatically determine the optimal time to create new radio links. There is also a need in the art for an improved apparatus and method to enable wireless stations in a wireless network to create and delete radio links in order to optimize bandwidth usage.

### SUMMARY OF THE INVENTION

To address the above-discussed deficiencies of the prior art, it is a primary object of the present invention to provide an apparatus and method for providing quality of service (QoS) management within a wireless mobile station.

The apparatus of the present invention comprises a quality of service (QoS) controller within a wireless mobile station. The quality of service (QoS) controller is capable of providing a radio link from the wireless mobile station to the wireless network. The radio link has a set of quality of service (QoS) parameters that support transmission and reception of data packets in a protocol that requires the set of quality of service (QoS) parameters.

The quality of service (QoS) controller of the present invention comprises a processor and a memory that contains quality of service (QoS) management application program, a quality of service (QoS) database, and a radio link database. The processor executes the quality of service (QoS) management application program to determine whether an individual data packet has a quality of service (QoS) requirement. If the data packet does not have a quality of service (QoS) requirement, then the quality of service (QoS) management application program causes the data packet to be transmitted over a selected radio link.

If the data packet does have a quality of service (QoS) requirement, then the quality of service (Qos) management application program provides a radio link that matches the quality of service (QoS) requirement for the data packet. The match may be an exact match, an approximate match, a best available match, or the like. The quality of service (QoS) management application program first determines whether a suitable radio link already exists by referring to the radio link database. If a suitable radio link already exists, then that radio link is selected from the radio link database and the data packet is transmitted on that radio link.

If a suitable radio link does not exist in the radio link database, then the quality of service (QoS) management application program creates a new radio link dynamically with suitable quality of service (QoS) parameters, adds the new radio link to the radio link database, and transmits the data packet on the new radio link.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary wireless network comprising an exemplary wireless mobile station according to the principles of the present invention;

FIG. 2 illustrates an exemplary wireless mobile station in greater detail according to an advantageous embodiment of the present invention; and

FIG. 3 is a flow diagram illustrating the operation of an exemplary wireless mobile station according to an advantageous embodiment of the present invention.

### DETAILED DESCRIPTION OF THE INVENTION

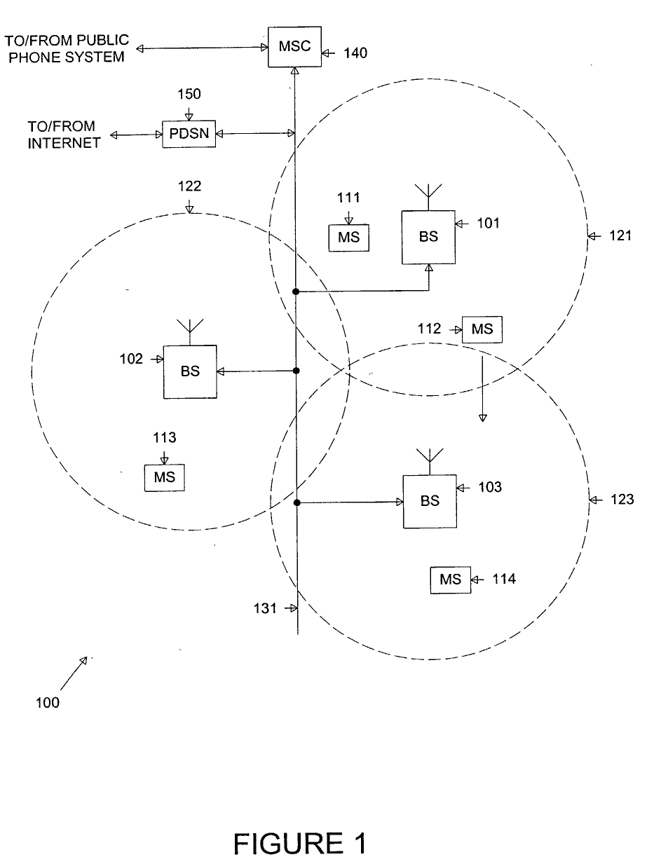

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless mobile station.

FIG. 1 illustrates exemplary wireless network 100, in which mobile station 111 operates according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over, for example, code division multiple access (CDMA) channels. Mobile stations 111-114 may be any suitable wireless communication devices, including conventional cellular telephones, Personal Communications System (PCS) handset devices, portable computers, telemetry devices, personal digital assistants, and the like, that are capable of communicating with the base stations via wireless radio links. Other types of access terminals, including fixed access terminals, may also be present in wireless network 100. However, for the sake of simplicity, only mobile stations are shown.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), each sector being illuminated by a directional antenna coupled to the base station. The embodiment of FIG. 1 illustrates the base station in the center of the cell. Alternate embodiments position the directional antennas in corners of the sectors. The system of the present invention is not limited to any particular cell site configuration.

In one advantageous embodiment of the present invention, each of the base stations BS 101, BS 102, and BS 103 comprises a base station controller (BSC) and one or more base transceiver subsystems (BTS). Base station controllers and base transceiver subsystems are well known to those skilled in the art. A base station controller is a device that manages wireless communications resources, including the base transceiver stations, for specified cells within a wireless communications network. A base transceiver subsystem comprises the radio frequency (RF) transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver subsystem in each of cells 121, 122, and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public switched telephone network (PSTN) and/or the Internet (not shown). Communications line 131 links each vocoder in the base station controller (BSC) with switch elements in the mobile switching center (MSC) 140. In one advantageous embodiment of the present invention, each link provides a digital path for transmission of voice signals in the pulse code modulation (PCM) format. Communications line 131 may be any suitable connection means, including a T1 line, a T3 line, a fiber optic link, a network backbone connection, and the like. In some embodiments, communications line 131 may be several different data links, where each data link couples one of BS 101, BS 102, or BS 103 to MSC 140.

BS 101, BS 102 and BS 103 transfer data signals, such as packet data, between each other and the Internet or other packet data network (not shown) via communications line 131 and packet data serving node (PDSN) 150. Packet data serving node (PDSN) 150 is well known to those skilled in the art.

Communications line 131 also provides a connection path to transfer control signals between MSC 140 and BS 101, BS 102 and BS 103 used to establish connections for voice and data circuits between MSC 140 and BS 101, BS 102 and BS 103. Those skilled in the art will recognize that the connections on communications line 131 may provide a transmission path for transmission of analog voice band signals, a digital path for transmission of voice signals in the pulse code modulated (PCM) format, a digital path for transmission of voice signals in an Internet Protocol (IP) format, a digital path for transmission of voice signals in an asynchronous transfer mode (ATM) format, or other suitable connection transmission protocol. Those skilled in the art will recognize that the connections on line communications line 131 may provide a transmission path for transmission of analog or digital control signals in a suitable signaling protocol.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located in cell site 121 close to the edge of cell site 123. The direction arrow proximate MS 112 indicates the movement of MS 112 towards cell site 123. At some point, as MS 112 moves into cell site 123 and out of cell site 121, a handoff will occur.

As is well known to those skilled in the art, the handoff procedure transfers control of a call from a first cell site to a second cell site. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

For example, assume that mobile stations 111-114 communicate with base stations BS 101, BS 102 and BS 103 over code division multiple access (CDMA) channels. As MS 112 moves from cell 121 to cell 123, MS 112 determines that a handoff is required based on detection of a control signal from BS 103, increased bit error rate on signals from BS 101, signal time delay, or some other characteristic. When the strength of the control signal transmitted by BS 103, or the bit error rate of signals received from BS 101, or the round trip time delay exceeds a threshold, BS 101 initiates a handoff process by signaling MS 112 and the target BS 103 that a handoff is required. BS 103 and MS 112 proceed to negotiate establishment of a communications link. The call is thereby transferred from BS 101 to BS 103. An idle handoff is a handoff between cells of a mobile device that is communicating in the control or paging channel, rather than transmitting voice and/or data signals in the regular traffic channels.

One or more of the wireless devices in wireless network 100 may be capable of executing real time applications, such as streaming audio or streaming video applications. Wireless network 100 receives the real time data from, for example, the Internet through packet data serving node (PDSN) 150 and through communications line 131 and transmits the real time data in the forward channel to the wireless device. For example, MS 112 may comprise a 3 G cellular phone device that is capable of surfing the Internet and listening to streaming audio, such as music from the web site “www.mp3.com” or a sports radio broadcast from the web site “www.broadcast.com.” MS 112 may also view streaming video from a news web site, such as “www.CNN.com.” To avoid increasing the memory requirements and the size of wireless phone devices, one or more of the base stations in wireless network 100 provides real time data buffers that can be used to buffer real time data being sent to, for example, MS 112.

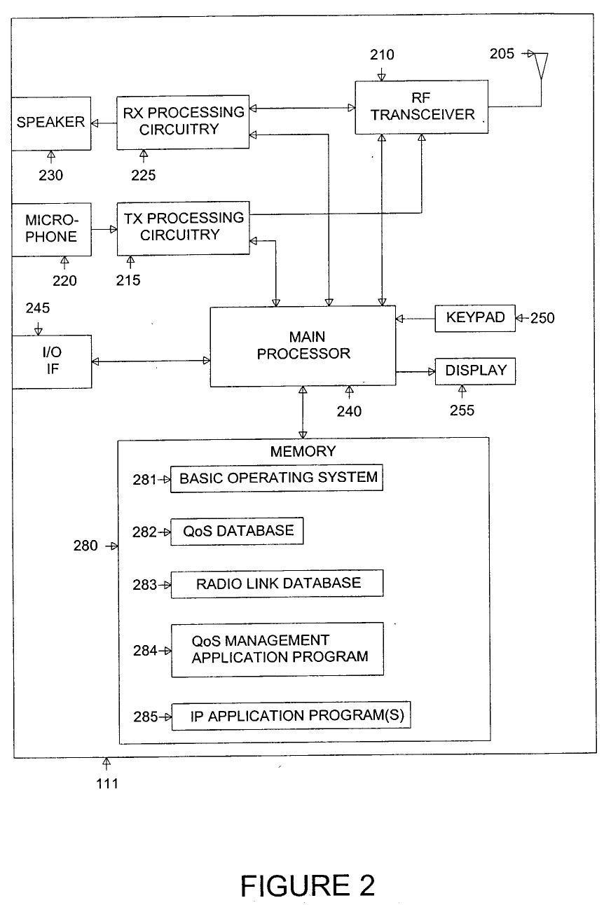

FIG. 2 illustrates exemplary wireless mobile station 111 in greater detail according to one advantageous embodiment of the present invention. Wireless mobile station 111 comprises antenna 205, radio frequency (RF) transceiver 210, transmitter (TX) processing circuitry 215, microphone 220, receiver (RX) processor circuitry 225, speaker 230, main processor 240, input/output (I/O) interface (IF) 245, keypad 250, and display 255. Wireless mobile station 111 further comprises memory 280, which stores basic operating system (OS) program 281, quality of service (QoS) database 282, radio link database 283, quality of service (QoS) management application program 284, and Internet protocol (IP) application program(s) 285.

RF transceiver 210 receives from antenna 205 an incoming RF signal transmitted by a base station of wireless network 100. RF transceiver 210 down-converts the incoming RF signal to produce an intermediate frequency (IF) or a baseband signal. The IF or baseband signal is sent to RX processing circuitry 225 that produces a processed baseband signal by filtering, decoding, and/or digitizing the baseband or IF signal to produce a processed baseband signal. RX processing circuitry 225 transmits the processed baseband signal to speaker 230 (i.e., voice data) or to main processor 240 for further processing (i.e., web browsing).

TX processing circuitry 215 receives analog or digital voice data from microphone 220 or other outgoing baseband data (i.e., web data, e-mail, interactive video game data) from main processor 240. TX processing circuitry 215 encodes, multiplexes, and/or digitizes the outgoing baseband data to produce a processed baseband or IF signal. RF transceiver 210 receives the outgoing processed baseband or IF signal from TX processing circuitry 215. RF transceiver 210 up-converts the baseband or IF signal to an RF signal that is transmitted via antenna 205.

In an advantageous embodiment of the present invention, main processor 240 is a microprocessor or microcontroller. Memory 280 is coupled to main processor 240. Memory 280 may be comprised of solid-state memory such as random access memory (PAM), various types of read-only memory (ROM), or Flash RAM. Memory 280 may also include other types of memory such as micro-hard drives or removable storage media that stores data. Main processor 240 executes basic operating system (OS) program 281 stored in memory 280 in order to control the overall operation of wireless mobile station 111. In one such operation, main processor 240 controls the reception of forward channel signals and the transmission of reverse channel signals by RF transceiver 210, RX processing circuitry 225, and TX processing circuitry 215, in accordance with well-known principles.

Main processor 240 is capable of executing other processes and programs resident in memory 280. Main processor 240 can move data into or out of memory 280, as required by an executing process. Main processor 240 is also coupled to I/O interface 245. I/O interface 245 provides the mobile station with the ability to connect to other devices such as laptop computers and handheld computers. I/O interface 245 is the communication path between these accessories and main controller 240.

Main processor 240 is also coupled to keypad 250 and display unit 255. Keypad 250 is used by the end user of mobile station 111 to enter data into mobile station 111. Display 255 may be a liquid crystal display capable of rendering text and/or at least limited graphics from Web sites. Alternate embodiments may use other types of displays.

According to the principles of the present invention, main processor 240 executes quality of service (Qos) management application program 284, accesses quality of service (QoS) database 282, and accesses and maintains radio link database 283. Main processor 240 and memory 280 comprise a quality of service (QoS) controller within mobile station 111. As will be more fully described, the quality of service (QoS) controller is capable of providing a radio link that has a selected set of quality of service (QoS) parameters that support transmission and reception of data packets in a protocol that requires such quality of service (QoS) parameters.

Quality of service (QoS) database 282 contains quality of service (QoS) requirements for various protocols supported by the Internet Protocol (IP). Quality of service (QoS) database 282 is not exhaustive. Quality of service (QoS) database 282 contains only protocols that have special quality of service requirements.

Different protocols have different requirements. For example, the File Transfer Protocol (FTP) has a variable bit rate, is not timing sensitive, and is asymmetric. The World Wide Web (WWW) has a variable bit rate, is timing sensitive, and is asymmetric. The Real Time Protocol (RTP) has a constant bit rate, is timing sensitive, and is symmetric.

Quality of service (QoS) database 282 contains relevant information for each protocol that is stored within quality of service (QoS) database 282. The information for each protocol includes a protocol identifier, bit rate information (constant or variable), whether the protocol is timing sensitive, and other various quality of service (QoS) parameters. The information that is stored in quality of service (QoS) database 282 does not change while mobile station 111 is in active use. Therefore quality of service (QoS) database 282 may be implemented in “read only memory” (ROM) within memory 280.

Radio link database 283 contains information concerning particular radio links that are active (or that can be activated) within mobile station 111. Radio link database 283 maps individual protocol identifiers to specific radio links that have the appropriate quality of service (QoS) parameters to support the transmission and reception of data packets with the indicated protocol. The information that is stored in radio link database 283 is dynamic and changes depending upon the type of applications that are run on mobile station 111. Entries in radio link database 283 are populated each time a radio link is created. Therefore radio link database 283 is implemented in “random access memory” (RAM) within memory 280.

According to the principles of the present invention, main processor 240 executes Internet Protocol (IP) application programs 285 and quality of service (QoS) management application program 284 stored in memory 280. QoS management application program 284 accesses the protocol identifier (PID) of each outgoing IP data packet to determine the protocol type of the data packet. QoS management application program 284 then compares the protocol identifier of the outgoing data packet with the QoS entries in QoS database 282 to see if the outgoing data packet has any “special” QoS requirement. If there is no match with the QoS entries in QoS database 282, then the outgoing data packet is processed normally and transmitted over a standard radio link. A standard radio link is one that does not provide any “special” QoS requirement.

If there is a match with the QoS entries in QoS database 282, then QoS management application program 284 marks the outgoing data packet for special QoS handling. QoS management application program 284 then accesses radio link database 283 to determine whether a radio link is active that has the appropriate quality of service (QoS) parameters to support the transmission of the data packet. A radio link may have the appropriate QoS parameters if it is an exact match, an approximate match, a best available match, or the like. QoS management application program 284 finds an appropriate radio link in radio link database 283, then the data packet is transmitted over that radio link.

If QoS management application program 284 does not find an appropriate radio link in radio link database 283, then QoS management application program 284 creates a new radio link using data that is stored in QoS database 282. QoS management application program 284 then adds the new radio link to radio link database 283. QoS management application program 284 then transmits the data packet over the new radio link.

While QoS management application program 284 is creating the new radio link, the outgoing data packet will either be queued for transmission or deleted. QoS management application program 284 makes the determination whether to queue or delete the outgoing data packet based on information stored in QoS database 282.

QoS management application program 284 is also capable of terminating a radio link if no data has been transmitted over the radio link for a specified period of time. In prior art wireless networks this feature is not available in the wireless mobile stations. For example, in a Universal Mobile Telecommunications System (UMTS) the Radio Network Controller (RNC) continually monitors the traffic volume on each radio link. The RNC will request a wireless mobile station to close one or more radio links when the traffic volume falls below some preselected threshold volume.

In an advantageous embodiment of the present invention, mobile station 111 can perform the same function. For example, after main processor 240 finishes executing an IP application program 285, main processor 240 is capable of executing QoS management application program 285 to terminate any radio link that was used to transmit data in connection with the IP application program 285. The radio links are closed immediately. There is no need to wait for a central controller (e.g., Radio Network Controller) to make a determination that the radio link does not have sufficient data traffic to remain open. This feature of the present invention allows rapid reuse of radio resources by other mobile stations that are served by the same base station.

In another advantageous embodiment of the present invention, mobile station 111 can collect statistical information concerning usage of the radio links. QoS management application program 284 is capable of obtaining such information and storing it in memory 280. The statistical information can be later retrieved from memory 280 and analyzed to improve the operation of the hardware and the software of mobile station 111. The task of collecting statistical information concerning the use of the radio links is presently performed by a central controller at a base station (e.g., Radio Network Controller). The statistical information collected by a central controller is “network oriented” in that the information pertains to the operation of the entire network. The statistical information collected by mobile station 111 of the present invention pertains only to the radio link usage of mobile station 111.

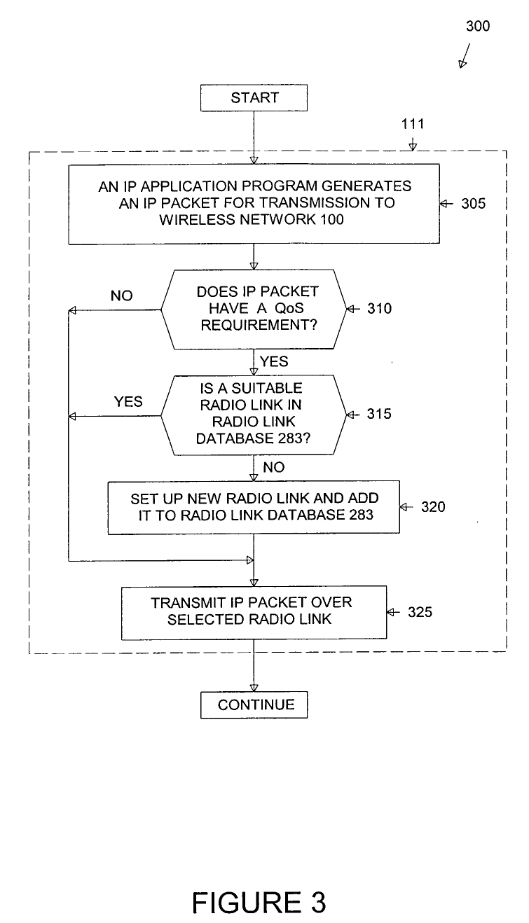

FIG. 3 is a flow diagram 300 that illustrates the operation of exemplary wireless mobile station ill according to an advantageous embodiment of the present invention. Mobile station 111 executes an Internet Protocol (IP) application program 285 that generates an IP data packet for transmission to wireless network 100 (step 305). QoS management application program 284 determines whether the data packet has a QoS requirement (decision step 310). If there is no QoS requirement, then the data packet is transmitted over a selected radio link (step 325).

If the data packet has a QoS requirement, then QoS management application program 284 consults radio link database 283 and determines whether there is a radio link available for the data packet that has suitable QoS capability (decision step 315). If there is a suitable radio link available, then that radio link is selected and the data packet is transmitted over the selected radio link (step 325).

If there is no suitable radio link available, then QoS management application program 284 creates a new radio link that is suitable and adds the new radio link to radio link database 283 (step 320). Then the new radio link is selected and the data packet is transmitted over the selected radio link (step 325). The process continues and is repeated for each data packet.

Although the present invention has been described in detail, those skilled in the art should understand that they could make various changes, substitutions and alterations herein without departing from the spirit and scope of the invention in its broadest form.

What is claimed is:

1. For use in a wireless network capable of communicating with wireless mobile stations located in a coverage area of the wireless network, an apparatus for providing quality of service (QoS) management within a wireless mobile station, said apparatus comprising:
a quality of service (QoS) controller coupled to said wireless network, said quality of service (QoS) controller capable of providing a radio link to said wireless network, said radio link having a set of quality of service (QoS) parameters that support transmission and reception of data packets in a protocol that requires said set of quality of service (QoS) parameters.

2. The apparatus as set forth in claim 1 wherein said quality of service (QoS) controller comprises:
a processor within said wireless mobile station;
a memory coupled to said processor, said memory containing a quality of service (QoS) management application program, a quality of service (QoS) database, and a radio link database.

3. The apparatus as set forth in claim 2 wherein said processor is operable to execute at least one Internet Protocol (IP) application program stored in said memory to generate at least one IP data packet for transmission through said wireless network.

4. The apparatus as set forth in claim 3 wherein said quality of service (QoS) management application program is operable to provide a radio link that has quality of service (QoS) parameters to transmit said at least one IP data packet.

5. The apparatus as set forth in claim 4 wherein said quality of service (QoS) management application program provides said radio link that has said quality of service (QoS) parameters by accessing said radio link database.

6. The apparatus as set forth in claim 4 wherein said quality of service (QoS) management application program provides said radio link that has said quality of service (QoS) parameters by creating a new radio link using data stored in said quality of service (QoS) database.

7. The apparatus as set forth in claim 6 wherein said quality of service (QoS) management application stores said new radio link in said radio link database.

8. The apparatus as set forth in claim 6 wherein during a time when said quality of service (QoS) management application is creating said new radio link, said quality of service (QoS) management application one of: queues an outgoing data packet for transmission and deletes an outgoing data packet.

9. The apparatus as set forth in claim 4 wherein said quality of service (QoS) management application program is operable to terminate said radio link after transmission of said at least one IP data packet on said radio link.

10. A wireless network comprising:
a plurality of base stations capable of communicating with wireless mobile stations located in a coverage area of said wireless network; and
an apparatus for providing quality of service (QoS) management within a wireless mobile station, said apparatus comprising:
a quality of service (QoS) controller coupled to said wireless network, said quality of service (QoS) controller capable of providing a radio link to said wireless network, said radio link having a set of quality of service (QoS) parameters that support transmission and reception of data packets in a protocol that requires said set of quality of service (QoS) parameters.

11. The wireless network as set forth in claim 10 wherein said quality of service (QoS) controller comprises:
a processor within said wireless mobile station;
a memory coupled to said processor, said memory containing a quality of service (QoS) management application program, a quality of service (QoS) database, and a radio link database.

12. The wireless network as set forth in claim 11 wherein said processor is operable to execute at least one Internet Protocol (IP) application program stored in said memory to generate at least one IP data packet for transmission through said wireless network; and
wherein said quality of service (QoS) management application program is operable to provide a radio link that has quality of service (QoS) parameters to transmit said at least one IP data packet.

13. The wireless network as set forth in claim 12 wherein said quality of service (QoS) management application program provides said radio link that has said quality of service (QoS) parameters by accessing said radio link database.

14. The wireless network as set forth in claim 12 wherein said quality of service (QoS) management application program provides said radio link that has said quality of service (QoS) parameters by creating a new radio link using data stored in said quality of service (QoS) database and wherein said quality of service (QoS) management application stores said new radio link in said radio link database.

15. The wireless network as set forth in claim 14 wherein during a time when said quality of service (QoS) management application is creating said new radio link, said quality of service (QoS) management application one of: queues an outgoing data packet for transmission and deletes an outgoing data packet.

16. The wireless network as set forth in claim 12 wherein said quality of service (QoS) management application program is operable to terminate said radio link after transmission of said at least one IP data packet on said radio link.

17. In a wireless network capable of communicating with wireless mobile stations located in a coverage area of the wireless network, a method for providing quality of service (QoS) management within a wireless mobile station, said method comprising the steps of:
providing a quality of service (QoS) controller in said wireless mobile station; and
providing a radio link to said wireless network, said radio link having a set of quality of service (QoS) parameters that support transmission and reception of data packets in a protocol that requires said set of quality of service (QoS) parameters.

18. The method as set forth in claim 17 wherein the step of providing a quality of service (QoS) controller in said wireless mobile station comprises the steps of:
providing a processor within said wireless mobile station; and
providing a memory coupled to said processor, said memory containing a quality of service (QoS) management application program, a quality of service (QoS) database, and a radio link database.

19. The method as set forth in claim 18 further comprising the steps of:
executing in said processor at least one Internet Protocol (IP) application program stored in said memory to generate at least one IP data packet for transmission through said wireless network; and
providing a radio link that has quality of service (QoS) parameters to transmit said at least one IP data packet by one of: accessing said radio link database and creating a new radio link using data stored in said quality of service (QoS) database.

20. The method as set forth in claim 19 further comprising the steps of:
storing said new radio link in said radio link database; and
during a time when said quality of service (QoS) management application is creating said new radio link one of:
queuing an outgoing data packet for transmission and deleting an outgoing data packet.

21. The method as set forth in claim 19 further comprising the step of:
terminating said radio link after transmission of said at least one IP data packet on said radio link.
